(19) United States
(12) Patent Application Publication
(10) Pub. No.: US 2009/0040118 A1
(43) Pub. Date: Feb. 12, 2009

(54) Electrical device having an antenna unit

(75) Inventors: John Chow, Saratoga, CA (US); Li-chun Wu, Tu-Cheng (TW); Der-Chung Hwang, Tu-cheng (TW); Yun-Cheng Hou, Tu-Cheng (TW); Fang-Chi Huang, Tu-cheng (TW); Wen-Zhao Huang, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/228,396

(22) Filed: Aug. 11, 2008

(30) Foreign Application Priority Data
Aug. 10, 2007 (CN) 200710025935.5

(51) Int. Cl. H01Q 1/24; H01Q 1/42

(52) U.S. Cl. 343/702; 343/872

(57) ABSTRACT

An electronic device (100) includes a metal shell (1) having a number of walls (11,12) and an antenna unit (3). The metal wall has an interior space (17) defined therebetween, at least one recess (110) defined on one of the wall (11), and a mating member (111) disposed around the recess and extending into the interior space. The antenna unit is received in the recess and has a locating portion (36) extending from a side portion thereof and pivotably engaging with the mating member. When the antenna unit is rotated from a closed position to an opening position, another side portion of the antenna unit extends outward from the recess.

### BACKGROUND OF THE INVENTION

1. Field of the Invention

The present invention relates to an electrical device, and more particularly an electrical device having an antenna unit mounted thereto.

2. Description of the Prior Art

With current developments in communication technology, such as Wireless Local Area Network (WLAN), Bluetooth and HomeRF, many desktop computers now have the function of wireless telecommunication. To achieve this function, an antenna is used with a desktop computer for receiving and transmitting signals. One conventional antenna used with a WLAN card having a Peripheral Component Interconnect (PCI) interface is externally mounted. The WLAN card is mounted in a PCI expansion slot in a desktop computer with a bracket covering a corresponding slot in a back cover of an enclosure of the desktop computer. The antenna is mounted to an exterior side of the bracket and electrically connects with the WLAN card through the bracket. When the desktop is moved, the antenna is exposed to an outside of the enclosure and can be easily damaged, so the performance of the antenna is not really reliable.

Hence, an improved electrical device is needed to solve the above problem.

### BRIEF SUMMARY OF THE INVENTION

One object of the present invention is to provide an electrical device having an antenna unit for effectively receiving and transmitting a signal.

The present invention provides an electronic device comprising a metal shell having a plurality of walls and an antenna unit. The metal shell has an interior space defined between the walls, at least one recess defined on one of the wall, a mating member disposed around the recess and extending into the interior space. The antenna unit is received in the recess and comprises a locating portion formed on a side portion thereof and pivotably engaging with the mating member, when the antenna unit is rotated from a close portion to an opening position, the another side portion of the antenna unit extends outward from the recess.

Advantages of the present invention are to provide an electrical device having an antenna unit which could be rotatably from a closed position to an opening position for reliably and effectively receiving and transmitting a signal.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is a perspective view of an electrical device in accordance with the present invention;

FIG. 2 is a perspective view of a metal shell of the electrical device;

FIG. 3 is an exploded perspective view of the electrical device as shown in FIG. 1;

FIG. 4 is an enlarged view of a mating member of the metal shell as shown in FIG. 2;

FIG. 5 is an exploded perspective view of an antenna unit; and

FIG. 6 is an exploded perspective view of the antenna unit as shown in FIG. 5, taken from another aspect.

### DETAILED DESCRIPTION OF THE INVENTION

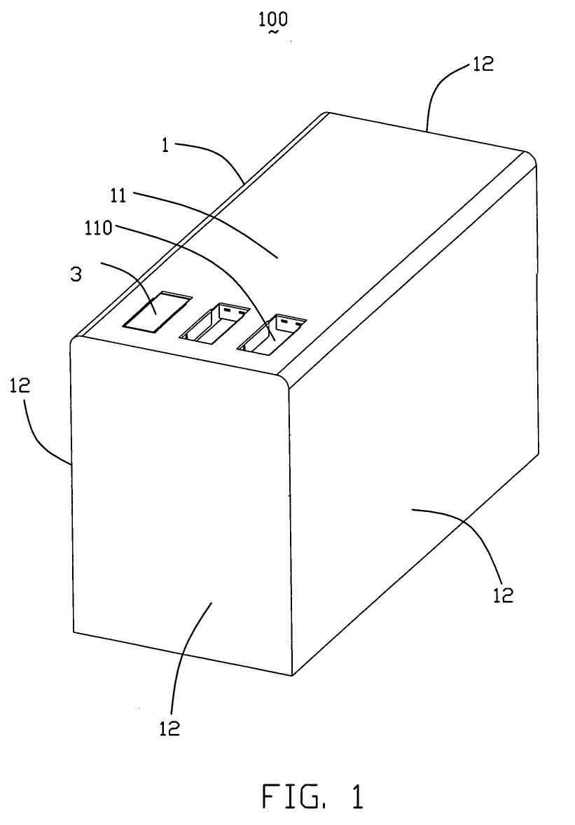

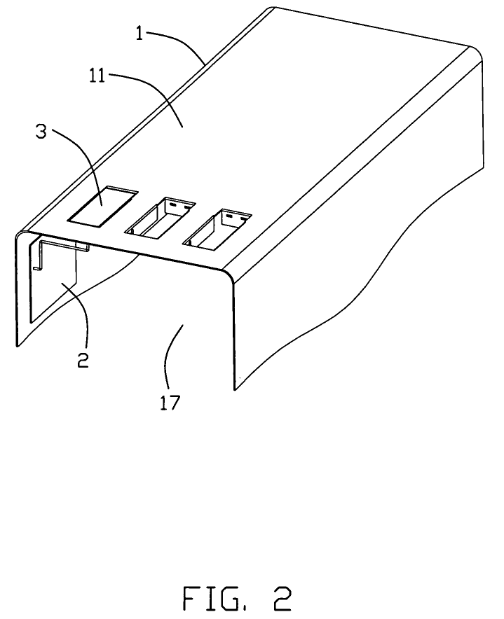

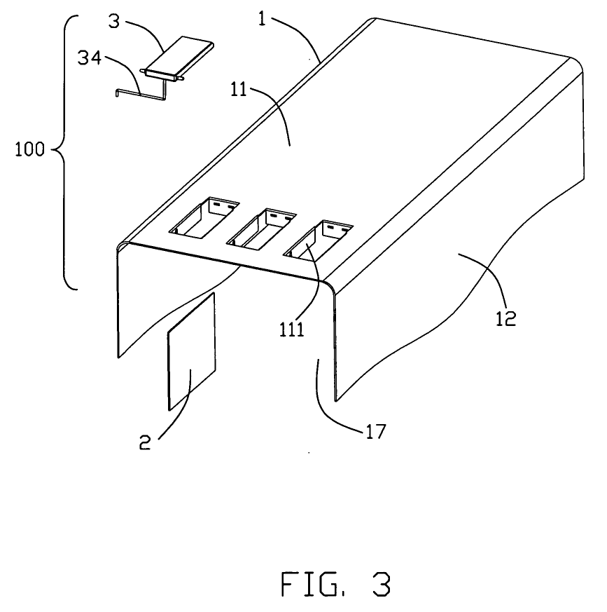

Reference will now be made to the drawing figures to describe the present invention in detail. Referring to FIGS. 1-3, an electrical device 100 comprises a metal shell 1 having an interior space 17 defined in the metal shell 1, an antenna unit 3 mounted to the metal shell 1 and a WLAN card 2 mounted to the interior space 17.

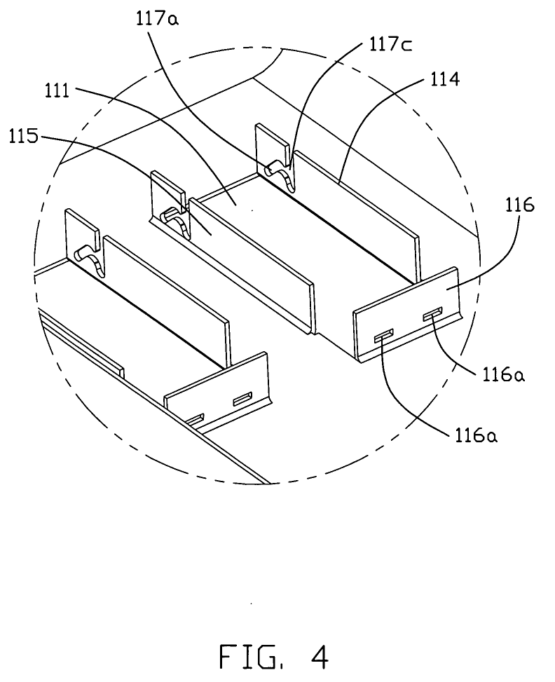

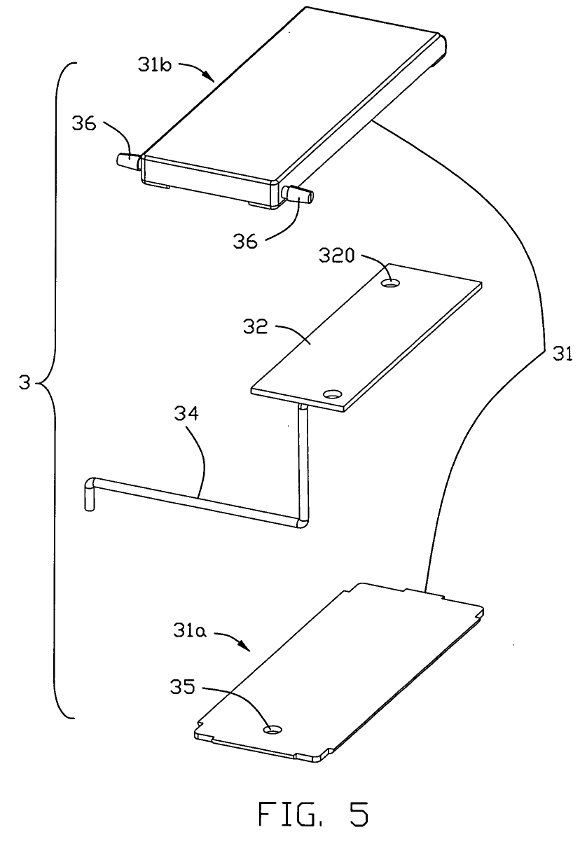

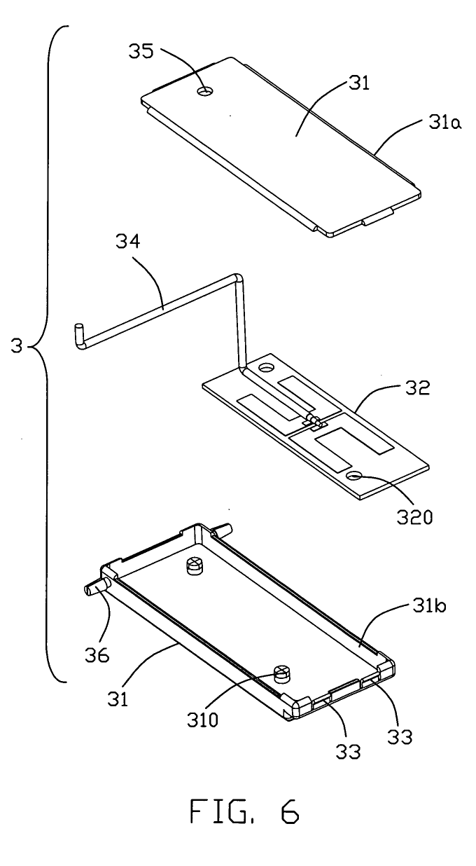

Referring to FIGS. 1-6, the metal shell 1 has a top wall 11 defining a plurality of recesses 110, and a plurality of side walls 12. The recess 110 is of rectangular shape. The top wall 11 has a mating member 111 comprising a first plate 116 and a pair of opposite side plates 114 and 115 bending from the edges of the recess 110 of the metal wall 1 and toward the interior space 17. The pair of opposite side plates 114, 115 respectively defines an opening 117 having a guiding slot 117c and an arced slot 117a in communication with the guiding slot 117c. The first plate 116 defines a pair of passages 116a.

The antenna unit 3 has a top cover 31b, a lower cover 31a cooperating with the top cover 31b and having a slit 35 defined thereon, a bracket portion 32 and a coaxial cable 34 which includes one end extending through the slit 35 for connecting to the WLAN card 2 and another end terminated to the bracket portion 32. The top cover 31b includes a locating portion 36 has opposite ends projecting from the opposite sides of the top cover 31b and rotatably extending through the arced slots 117a of the opening 117, a pair of posts 310 disposed thereon for engaging with the corresponding holes 320 formed on the bracket portion 32, and a plurality of embosses 33 disposed on one side thereof for locking with the passages 116a of the first plate 116.

The bracket portion 32 of the antenna unit 3 is a Planar Antenna. The bracket portion 32 has two metallic strips (not labeled) disposed on an upper surface for receiving and transmitting signals. In another embodiment, The bracket portion 32 could be replaced by a Linear Antenna or an Array Antenna.

During assembly, the locating portion 36 of the top cover 31b of the antenna unit 3 is guided by the guiding slot 117c and received in the arced slot 117a. The antenna unit 3 is received in the recess 110 in a closed position. When the antenna unit 3 is rotated manually from a closed position to an opening position, another side portion of the cover 31 extends outward of the recess 110 of the metal shell 1 for effectively transmitting and receiving signals. When the antenna unit 3 is retained in the opening position, the location portion 36 of the top cover 31b is moved to a communication area (not labeled) of the arced slot 117a and the guiding slot 117c, and the location portion 36 is abut against the communication area.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electronic device, comprising:
a metal shell having a plurality of walls, an interior space defined between the walls, at least one recess defined on one of the walls, and a mating member disposed around the recess and extending into the interior space; and
an antenna unit received in the recess and comprising a locating portion formed on a side portion thereof and pivotably engaging with the mating member, when the antenna unit is rotated from a closed position to an opening position, another side portion of the antenna unit extends outward from the recess.

2. The electronic device as claimed in claim 1, wherein said antenna unit has a cover, a bracket portion and a coaxial cable connected to the bracket portion.

3. The electronic device as claimed in claim 2, further comprising a WLAN (Wireless Local Area Network) card assembled to the interior space and connected to one end of the coaxial cable.

4. The electronic device as claimed in claim 2, wherein said locating portion has opposite ends projecting from the opposite sides of the cover for engaging with the mating member.

5. The electronic device as claimed in claim 2, wherein said cover comprises a top cover and a lower cover cooperated with each other.

6. The electronic device as claimed in claim 5, wherein said top cover has a pair of posts, wherein the bracket portion comprises corresponding holes formed thereon for receiving the posts.

7. The electronic device as claimed in claim 1, wherein said mating member has a plurality of plates bending toward the interior space from the edges of the recess of the metal shell.

8. The electronic device as claimed in claim 7, wherein one of the plates has a plurality of passages defined thereon for locking with a plurality of embosses disposed on one side of the cover.

9. The electronic device as claimed in claim 7, wherein a pair of opposite plates respectively defines an opening, the locating portion rotatably engaging with the openings.

10. The electronic device as claimed in claim 9, wherein said opening comprises a guiding slot and an arced slot in communication with the guiding slot for coupling with the locating portions of the antenna unit.

11. The electronic device as claimed in claim 1, wherein said recess is of rectangular shape.

12. An antenna unit used in an electronic device which has a metal shell defining a recess thereon, comprising:
a cover received in the recess and having a locating portion formed on a side portion of the cover and pivotably engaging with the metal shell, when the antenna unit is rotated from a closed position to an opening position, another side portion of the cover extends outwardly from the recess;
a bracket portion assembled to the cover; and
a coaxial cable mounted to the bracket portion.

13. The antenna unit as claimed in claim 12, wherein said locating portion has opposite ends projecting from the opposite sides of the cover for engaging with the mating member.

14. The antenna unit as claimed in claim 12, wherein said cover comprises a top cover and a lower cover cooperating with the top cover.

15. The antenna unit as claimed in claim 14, wherein said top cover has a pair of posts, wherein the bracket portion comprises corresponding holes formed thereon for receiving the posts.

16. An antenna unit assembly comprising:
a metallic shell defining a mating member having a plurality of inwardly extending plates which are split from the shell to form an opening in the shell and commonly define a receiving space in communication with the opening;
an antenna unit pivotally mounted in said receiving space and defining a cover device enclosing a planar antenna therein;
a wireless card located under the shell and connected to the planar antenna;
wherein
the antenna unit is essentially coplanar with an exterior face of the shell when said antenna unit is located in a closed position, and a pivotal axis of said antenna unit extends parallel to said exterior face.

17. The antenna unit assembly as claimed in claim 16, wherein the pivotal axis of said antenna unit is moved between two different positions with regard to the shell when said antenna unit is moved between the closed position and an open position so as to avoid interference between the antenna unit and the shell.

18. The antenna unit assembly as claimed in claim 16, wherein the planar antenna defines a hole and the cover device defines a post to be received in said hole for retaining the planar antenna in the bracket unit.

19. The antenna unit assembly as claimed in claim 16, wherein the cover device defines a locating post and the plate defines a guiding slot for holding the antenna unit in position with regard to the mating member.
